(19) United States
(12) Patent Application Publication
(10) Pub. No.: US 2021/0342902 A1
(43) Pub. Date: Nov. 4, 2021

(54) AUTOMATED BILLING VERIFICATION SYSTEM

(71) Applicant: Black Hills IP Holdings, LLC, Minneapolis, MN (US)

(72) Inventor: Steven W. Lundberg, Edina, MN (US)

(21) Appl. No.: 17/307,823

(22) Filed: May 4, 2021

Related U.S. Application Data
(63) Continuation of application No. 63/019,839, filed on May 4, 2020.

(51) Int. Cl. G06Q 30/04; G06F 40/42

(52) U.S. Cl. CPC G06Q 30/04; G06F 40/42

(57) ABSTRACT

Disclosed herein are a system and method for creating client formatted billing entries by receiving billing information including an activity description, associating a universal code with the billing information based on the activity description, applying a customer code to the billing information associated with the universal code, and substituting a revised activity description for the activity description. The revised activity description may correspond to the customer code to produce a client formatted billing entry. The billing information also may be analyzed by language recognition or other natural language processing software to detect and categorize key words or phrases in the activity description for association with the universal code.

### CLAIM OF PRIORITY

This application claims the benefit of priority under 35 U.S.C. § 119(e) to U.S. Patent Application Ser. No. 63/019,839, filed on May 4, 2020, which is incorporated by reference herein in its entirety.

### TECHNICAL FIELD

The application is directed to billing systems, and more specifically, to billing systems having structured billing entries.

### BACKGROUND

Many various types of businesses produce bills for services rendered or goods sold to various customers throughout the course of their work. In general, the business will record time spent on a given project for a customer, so that the business may later produce a detailed bill for that customer, including information on the tasks performed, the persons performing those tasks, and the hourly rate at which the customer will be charged.

To this end, in many businesses, employees record their time working on various projects for one or more customers. The employee may track the time they have spent on a particular project or matter for a customer for purposes of later creating a customer bill for that project that indicates the specific tasks the employee completed. In general, when the employee records their time spent on the project, the employee may insert a description of the activities or tasks they performed while working on that project.

For example, in a law firm, an associate attorney may work on a contracts matter for a customer company. The associate attorney may record their time and perhaps may describe the activity they completed that day as “In reviewing and revising contract clauses.” This description, along with bibliographic information, such as the project and customer number, date, and identity of the associate attorney, plus a numerical value for that time (e.g., a billing rate or cost), may be inputted into the law firm's billing system to create billing records. The finance department may take in this information and produce a bill to the customer.

### SUMMARY

Disclosed is an automated system and method for verifying billing entries and converting billing entries to uniformly coded and styled bills. The standardized billing entries may be sent to a customer with fewer instances of bounce back from the customer due to particular “red flags” in the customer billing system, such as incorrect phrasing or keywords, or un-coded entries.

Many businesses produce detailed bills to customers. These detailed bills may have specific billing entries that include activity descriptions. Often, if the customer receives a bill with billing entries or activity descriptions that the customer's bill intake system does not recognize, the bill is rejected by that customer. Such bills may be bounced back to the originating business, causing the finance department at that originating business to spend time reworking the bill so that the formatting and language aligns with the customer's billing system. This may cause a significant amount of rework for finance departments, and a delay in bills being paid.

The disclosed methods and systems allow for creation and verification of bills with customer coded billing entries. The billing entries are coded and formatted according to customer rules, and the activity descriptions are converted to standardized descriptions. As the bills are formatted according to the customer rules, there is a lower likelihood of the bill being bounced back from the customer. This may reduce the amount of time spent at the originating business correcting bills, and help ensure bills are paid in a timely manner.

In a first aspect, a method of standardizing a billing entry may include receiving billing information including an activity description, associating a universal code with the billing information based on the activity description, applying a customer code to the billing information based on the universal code, and substituting a revised activity description for the activity description, the revised activity description corresponding to the customer code to produce the customer formatted billing entry.

In a second aspect, a system for standardizing billing entries may include a memory that stores instructions for implementing a billing entry utility, a billing entry transfer engine, a billing entry coding engine, and one or more processors that execute the instructions to perform operations including: the billing entry utility receiving an uncoded billing entry comprising an activity description, the billing entry transfer engine associating a universal code with the uncoded billing entry based on the activity description to produce a universally coded billing entry, and the billing entry coding engine associating a customer code with the universally coded billing entry to produce a customer coded billing entry comprising a customer formatted activity description.

In a third aspect, a non-transitory computer-readable storage medium may include instructions that, when executed by one or more processors, cause the one or more processors to create a customer formatted billing entry by performing operations to: receive billing information including an activity description, associate a universal code with the billing information based on the activity description, apply a customer code to the billing information based on the universal code, and substitute a revised activity description for the activity description, the revised activity description corresponding to the customer code to produce the customer formatted billing entry.

In some embodiments, the disclosed method provides a mechanism to allow execution of automated actions in an electronic system based on activity description included with a billing entry.

In some embodiments, the disclosed method provides a mechanism for a timekeeper to produce a coded billing entry, regardless of the server, application, program, or user interface from which the billing entry originates.

In some embodiments, the disclosed method provides a mechanism for a customer to receive a billing entry including a code for automatically executing an action in the customer billing system based on the code.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram depicting an example billing system for standardizing billing entries.

FIG. 2 is a block diagram depicting an example billing entry.

FIG. 3 is a block diagram depicting an example billing report.

FIG. 4 is a block diagram depicting a method of automatically revising a billing entry such that it is in a valid format according to a customer's billing rules.

FIG. 5 is a block diagram depicting an accounting system for processing of standardized billing entries.

FIG. 6 is a block diagram depicting a method of transferring an un-coded billing entry to a standardized billing entry in an example.

FIG. 7 is a block diagram of a typical, general-purpose computer that may be programmed into a special purpose computer suitable for implementing one or more embodiments of the automated billing system disclosed herein.

### DESCRIPTION

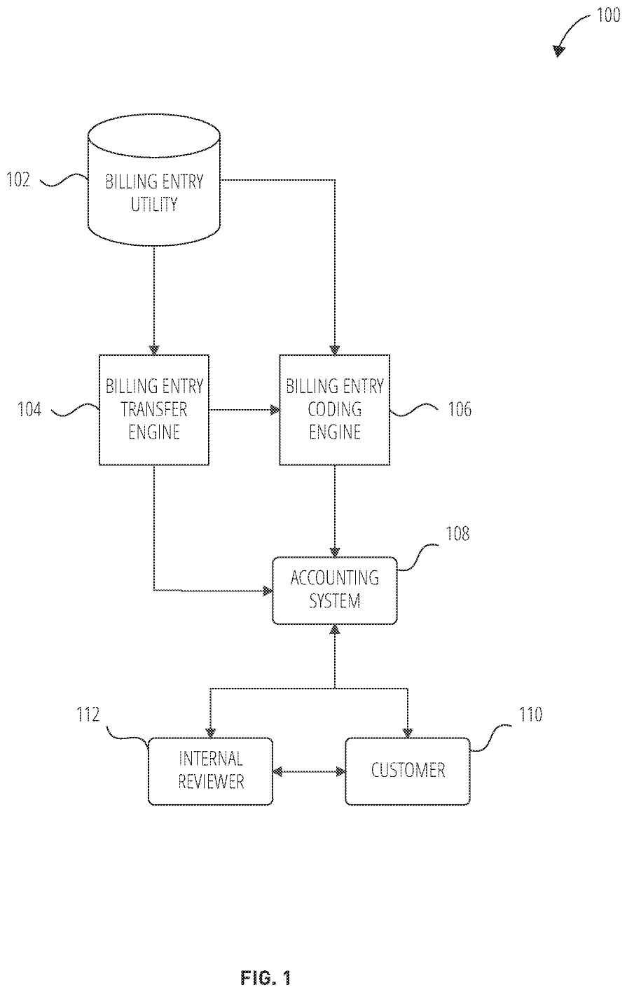

The following description with respect to FIGS. 1-7 sufficiently illustrates specific embodiments to enable those skilled in the art to practice them. Other embodiments may incorporate structural, logical, process, and other changes. Portions and features of some embodiments may be included in, or substituted for, those of other embodiments. Embodiments set forth in the claims encompass all available equivalents of those embodiments.

### Terminology

As used herein, “activity description,” refers to text in a billing entry describing actions or tasks done by a timekeeper for a particular matter.

As used herein, “billing entry,” refers to a data entry describing billing activity done by a timekeeper, such as, but not limited to, an activity description, a record of the amount of time spent on the task, a list of the timekeeper's billing rate, and other bibliographic information.

As used herein, “billing entry utility,” refers to a computerized program for receiving billing entries.

As used herein, “billing information,” refers to bibliographic information present in or associated with a billing entry.

As used herein, “billing system,” refers to an accounting or financial system for receiving and processing billing entries, such as to convert billing entries to bills to customers.

As used herein, “customer code,” refers to a code or structured data to associate with a billing entry, where that code indicates or identifies what type of billing entry is present, and/or indicates or induces actions within a computerized system, that is specific to a customer.

As used herein, “customer formatted billing entry,” refers to a billing entry that has been associated with one or more codes that are customer specific.

As used herein, “free text,” refers to unstructured descriptive text, such as in a billing entry.

As used herein, “invoice,” “bill,” or “tab,” refers to a commercial document issued by a seller to a buyer, relating to a sale transaction and indicating the products, quantities, and agreed prices for products or services the seller had provided the buyer. Payment terms are usually stated on the invoice.

As used herein, “structured text” or “structured data” refers to data that is organized in a standard format such that a recipient may read the data and institute an automated computing system action without human interpretation of the data.

As used herein, “timekeeper,” refers to a person who is working on and recording time on an activity or matter, where that time may be billed to a customer.

As used herein, “universal code,” refers to a code or structured data to associate with a billing entry, where that code indicates or identifies what type of billing entry is present, and/or indicates or induces actions within a computerized system.

As used herein, “unstructured text” or “unstructured data” refers to data that is not organized in a standard format, for example, text in the body of a billing entry.

### OVERVIEW

When a customer receives a bill with a number of billing entries, depending on the size of the customer, the bill may be fed into a review system, whether manual or automated. If any of the billing entries in the bill are incorrectly formatted or use language that the customer review system does not approve of, the customer may bounce the bill back to the service provider.

Discussed herein is a computerized method of automatically formatting billing entries to avoid such bounce back. The method may include analyzing language in billing entry text to determine what kind of task was performed. The billing entry may then be assigned an in-house, universal code, associated with that kind of task. A system may associate that universal code with a customer specific set of instructions, such as applying a customer code to the billing entry, reformatting the billing entry, or other automated actions, prior to finalizing the bill.

### Billing System

FIG. 1 depicts an example billing system 100 for use in producing verified and standardized billing entries for placement on a bill to a customer. The billing system 100 may include a billing entry utility 102, a billing entry transfer engine 104, a billing entry coding engine 106, an accounting system 108, a customer system 110, and an internal reviewer 112. The billing system 100 may be used for standardizing un-coded billing entries such that the produced standardized billing entries are ready for inclusion on a bill to a customer.

The billing entry utility 102 may be a utility with which an employee or other worker enters his or her time and billing rate for a project. For example, billing entry utility 102 may be a program such as a timekeeping program, a docketing program, a work management program, or other electronic program including a function for receiving billing entry data. The billing entry utility 102 may receive, for example, unstructured billing data, including information such as billing amount, timekeeper information, and an activity description.

The billing entry transfer engine 104 may receive billing entry data from the billing entry utility 102. The billing entry from the billing entry utility 102 may be, for example, un-coded or partially coded. The billing entry transfer engine 104 converts the billing entry from the billing entry utility 102 to a universal code. Some example codes are shown in the below Table 1.

TABLE 1

| Initial Activity Description | Universal Code |
|---|---|
| Preparing office action response | UVSL-US-010 |
| Drafting claims | UVSL-US-020 |
| Conducting patentability search | UVSL-US-030 |

The billing entry coding engine 106 may be one or more programs configured to apply one or more customer codes to the billing entry. The billing entry coding engine 106 may receive an un-coded billing entry, a partially coded billing entry, or a universally coded billing entry from the billing entry transfer engine 104. In some cases, the billing entry coding engine 106 may receive the billing entry of interest directly from the billing entry utility 102.

The billing entry coding engine 106 may read the incoming billing entry. In particular, the billing entry coding engine 106 may review the incoming billing entry for one or more universal codes. Based on the detected universal code, the billing entry coding engine 106 may apply a customer code to the billing entry to produce a customer coded billing entry. The customer code may, for example, be correlated with the universal code. Some example codes are shown in the below Table 2.

TABLE 2

| Initial Activity | | | Revised Activity |
|---|---|---|---|
| Description | Universal Code | Customer Code | Description |
| Preparing office | UVSL-US-010 | US-Customer-022 | Preparing |
| action response | | | amendment |
| Drafting claims | UVSL-US-020 | US-Customer-013 | Drafting |
| | | | application |
| Conducting | UVSL-US-030 | US-Customer-054 | Search analysis |
| patentability | | | |
| search | | | |

The accounting system 108 may be a system for receiving and interpreting billing entries. The accounting system 108 may include an intake process for receiving coded billing entries, a process for sorting the billing entries, and a process for assigning the billing entries to a bill for a customer. In some cases, the accounting system 108 may be an automated system. In some cases, the accounting system 108 may be partially automated. In some cases, the accounting system 108 may be manual.

The customer system 110 may be a customer billing system for receiving bills from the originating business. The customer system 110 may be partially or fully automated. The customer system 110 may receive bills from the accounting system 108 and interpret those bills. If the bills received fall within a pre-determined category, the customer system 110 may accept the bill for payment. For example, if the customer system 110 receives a bill that has activity descriptions that match requirements for the customer, then the customer system 110 may process the bill for payment.

The internal reviewer 112 may be, for example, a billing person such as an attorney or paralegal, the case manager, an accounting or finance professional, or someone else as appropriate from inside the business. The internal reviewer 112 may review the revised bill with the standardized billing entry prior to the bill being sent to the customer system 110. The internal reviewer 112 may, in some cases, revise or amend the bill as needed prior to entry into the customer system 110.

### Billing Entry

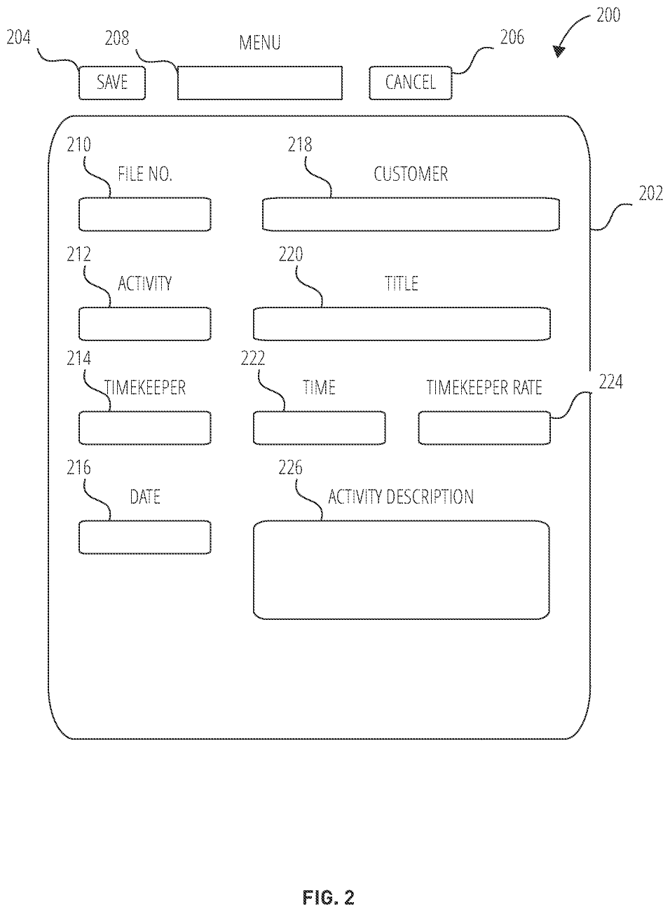

FIG. 2 depicts an example billing entry 200 of the type the billing system 100 of FIG. 1 may receive. The billing entry 200 may include an un-coded billing entry 202, a save button 204, a cancel button 206, a drop-down menu 208, a file no. field 210, an activity field 212, a timekeeper field 214, a date field 216, a Customer field 218, a Title field 220, a Time field 222, a timekeeper rate field 224, and an activity description field 226.

The billing entry 200 may, for example, be an entry inserted into the billing system 100 by a manual user, such as a timekeeping employee or contractor. Examples of timekeepers may include personnel who work on or complete any tasks which would be billable to the customer. For example, in a law firm setting, a paralegal or attorney might be a timekeeper. The billing entry 200, as entered by the user, may be an un-coded billing entry, including unstructured billing data, such as free-form text or other unstructured data not coded for automated review in a billing system, such as billing system 100.

The un-coded billing entry 202 may be received by a user interface containing one or more fields for collecting various unstructured billing information about the billing entry. The user interface may be, for example, an application or program on a computer, such as a web-based software, or a locally saved program. The user interface may be interactive with a mouse and keyboard, or with a touch screen, or a combination thereof. The user interface may include options to save (e.g., save button 204), to cancel entry (e.g., cancel button 206), edit features, submit features, or other commands that the user may input to the program through the user interface.

The user interface may include one or more fields for collection of unstructured billing data. For example, the user interface may include a file no. field 210, activity field 212, timekeeper field 214, date field 216, customer field 218, title field 220, time field 222, timekeeper rate field 224, and activity description field 226. Additionally, fields may include, for example, additional codes or descriptions associated with the activity, a customer associated description or code, additional timekeeper data such as name or position, geographic information, matter status, most recent task completed on the matter, date and time of the billing entry, or additional information.

The date field 216 may be configured to receive information such as the time, date, day of the week, and other temporal information, for when the billing activity was completed. The user interface may also have an additional date field for inclusion of the date and time at which the billing entry was inputted into the billing system 100.

File no. field 210 may include, for example, a docket number or other identifying matter number, whether used internally and the business entering the billing entry, or a number used by the customer. Similar identifying fields may include the activity field 212, which may receive additional information related to what type of tasks are being done for the particular file or matter number.

The customer field 218 and the title field 220 may provide additional identification to the billing entry. Respectively, they may identify the customer that the work was done on behalf of, and the title of the project that was worked on.

Timekeeper field 214 may be for a timekeeper name or identification, such as a timekeeper ID number. In some cases, the timekeeper field 214 may be for a timekeeper's initials. The timekeeper rate field 224 may be for the associated cost or going rate of that timekeeper. This field may, in some cases, be linked to the timekeeper field 214, so that filling in of the timekeeper field 214 automatically fills in the timekeeper rate field 224. The timekeeper rate field 224 may receive information, for example, in the form of currency per time, such as dollars per number of hours.

The time field 222 may denote the amount of time spent on the task described in the billing entry. The time field 222 may, for example, receive data in hours and minutes, in tenths of an hour, in quarters of an hour, or other appropriate measurements of time. The amount of time in the time field 222 and the timekeeper rate information from the timekeeper rate field 224 may be used to calculate a dollar amount for the billing entry. In some cases, a flat fee could be entered into the user interface, overriding this calculation.

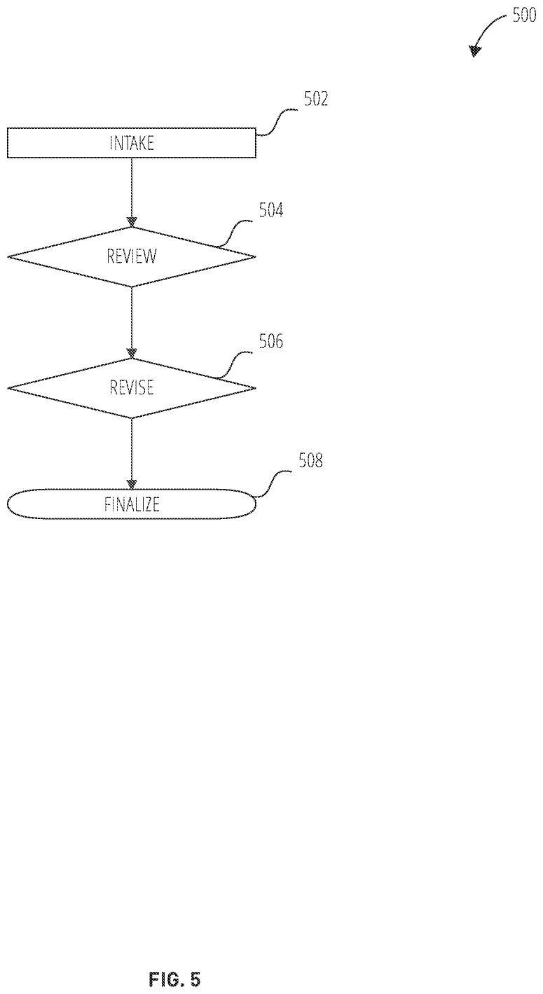

The activity description field 226 may be for insertion of the timekeeper's own description of the work performed. As such, the activity description field 226 may receive a free form, unstructured activity description. For example, if the timekeeper drafted a memorandum, that timekeeper could insert “In drafting memo,” or, “Time in preparing and writing memorandum RE case question A.” Both entries could conceivably describe the billing entry activity, and both, or other free form descriptions, could be received through the activity description field 226. Additional example of free form billing entry text are discussed in more depth with reference to FIG. 5 below.

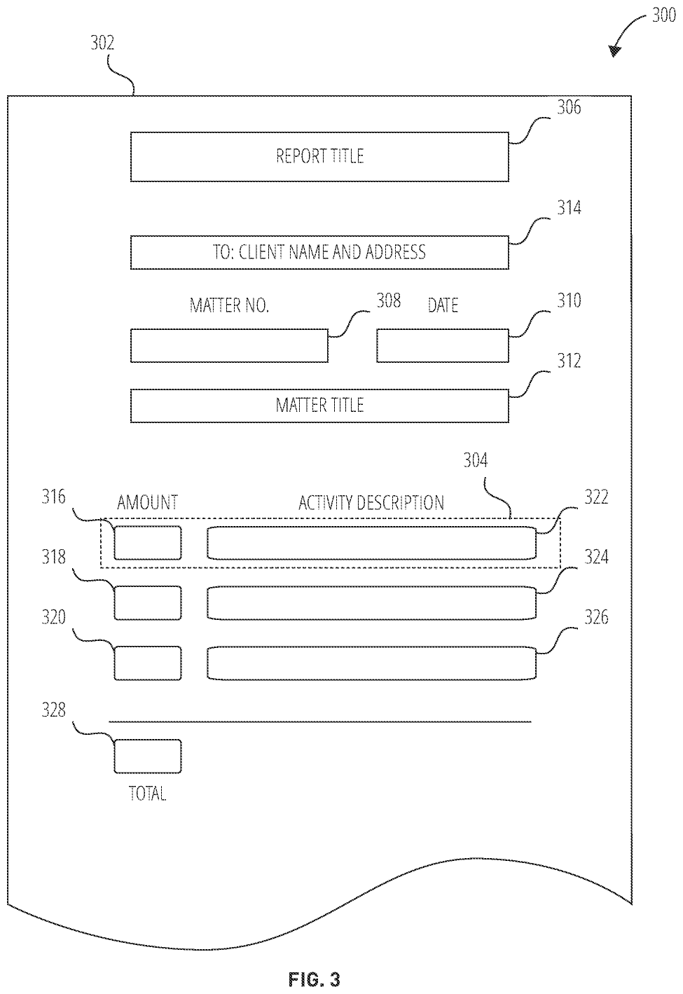

The inclusion of a free form billing description, or other unstructured billing data, may have an effect on the bill sent out to the customer. In some cases, particular words, phrases, or lengths of billing entry activity descriptions may cause customer's billing systems to reject bills from another entity. An example bill to a customer may be seen in FIG. 3, discussed below.

### Billing Report

FIG. 3 shows an example billing report 300, which includes multiple billing entries. The billing report 300 includes bill 302 with description section 304, a report title field 306, a matter number field 308, a date field 310, a title field 312, an address field 314, billing entry amounts 316, 318, 320, revised activity descriptions 322, 324, 326, and a total amount 328.

In billing report 300, bibliographic data may be included in fields 306, 308, 312, and 314. This bibliographic data may indicate to the person reviewing the billing report 300 what matter, case, or project, this bill is or should be applied to. This bibliographic information may assist in sorting the billing report to the appropriate system or person for review or handling.

Billing entry amounts 316, 318, 320, and activity descriptions 322, 324, 326, indicate what the bill is for, what work was completed, and how much that work cost. If the activity descriptions 322, 324, 326, are standardized according to customer codes and rules, it is more likely that the customer's system and finance department will accept the bill for payment.

### System for Automatically Revising Billing Entries

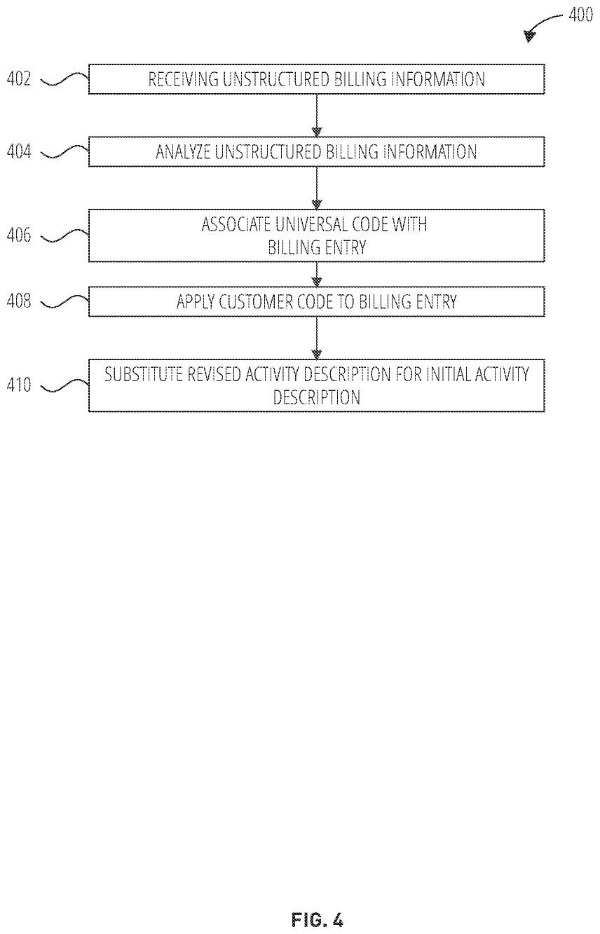

FIG. 4 depicts a method 400 of automatically revising a billing entry such that it is in a valid format according to a customer's billing rules.

In step 402, method 400 may include receiving unstructured billing information including an initial activity description. For example, a timekeeper may enter billing information into a billing entry utility (e.g., billing entry utility 102 in FIG. 1), such as a program structured to receive billing information. The timekeeper may enter information such as that discussed with respect to the example billing entry 200 above, such as file number, activity, timekeeper, date, customer, title, time, timekeeper rate, and activity description, among other pieces of information. The unstructured billing information may be received in a billing entry utility, such as a software program, web-based program, or other application for receiving this information.

In step 404, method 400 may include analyzing the unstructured billing information, including the initial activity description. For example, the activity description text may be analyzed by language recognition or other natural language processing to extract key words and/or to classify the text into a particular classification identifying the type of activity.

In step 406, method 400 may include associating a universal code with the billing entry based on the initial activity description. The language used in the activity description may be associated with a universal code based on, for example, a look-up table or matching in a database. The universal code, for example, may indicate internally what kind of activity was completed. The universal code may, in some cases, indicate actions that may be taken regarding the billing entry.

In step 408, method 400 may include applying a customer code to the billing entry based on the universal code. Based on the universal code associated with the billing entry, and the customer identification, a series of rules may be applied so that one or more customer codes are associated with the billing entry. The customer codes may, for example, indicate a revised activity description that should replace the initial activity description. In an example, a customer code may indicate whether a billing entry should be aggregated or held for a bill.

In step 410, method 400 may include substituting a revised activity description for the initial activity description. The revised activity description may correspond to the customer code, and result in a standardized billing entry for sending to the customer.

### Accounting System

FIG. 5 is a block diagram depicting an accounting system 500 for processing of standardized billing entries. The accounting system 500 may have an intake 502, a reviewer 504, a reviser 506, and a finalizer 508.

The accounting system 500 may receive a billing entry at intake 502 from a billing entry utility. In some cases, the billing entry utility may be partially or fully integrated with the accounting system 500, or the billing entry utility and the accounting system 500 may be in automated communication with each other. In some cases, the billing entry utility may periodically send billing entry information to the accounting system 500.

In some cases, the billing entries may be revised, with one or more associated universal codes, and/or one or more associated customer codes, when they enter the accounting system 500. In some cases, the system for automatically revising billing entries and associated universal and/or customer codes may be integrated with the accounting system 500.

When the billing entries are received by the accounting system 500, the reviewer 504 may review each billing entry as it is taken in, or aggregate and review billing entries in bulk. The reviewer 520 may be an application, program, or person, that analyzes the billing entry information, and verifies the billing entry. For example, the reviewer may verify the billing entry universal codes, customer codes, activity description format, or other information.

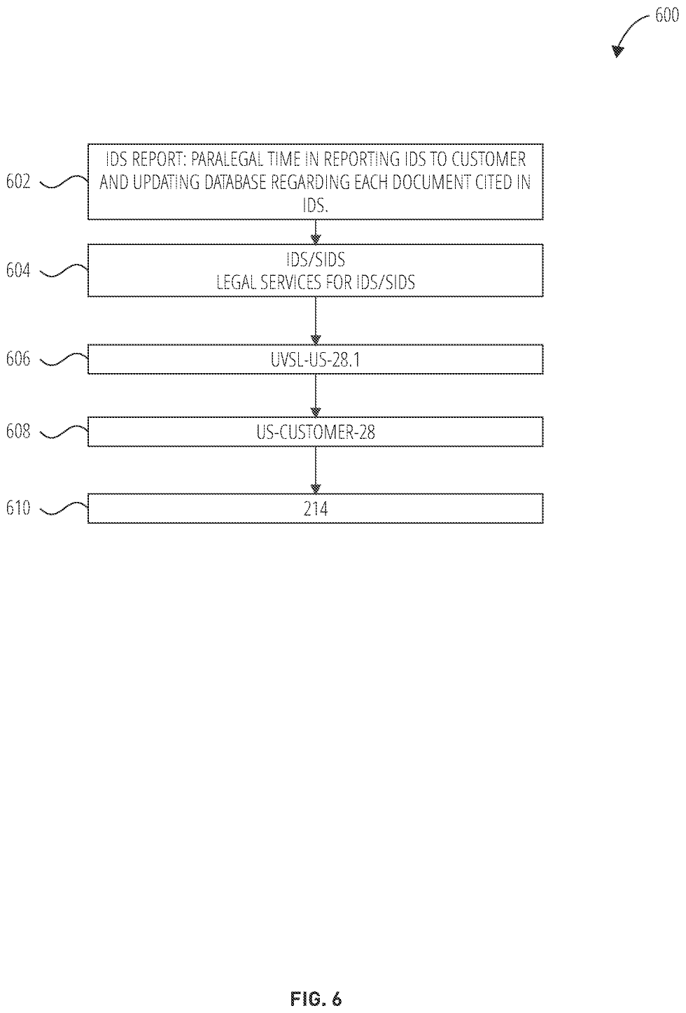

Once reviewed, the billing entries may be sent to the reviser 506. In some cases, the reviewer 504 and reviser 506 programs may be partially or fully integrated. The reviser 506 may edit, as desired, various portions of the billing information. In some cases, the reviser 506 may additionally add or revise universal or customer codes associated with the billing entry, such as discussed below with reference to FIG. 6.

The finalizer 508 may prepare the final bill to the customer, such as billing report 300 discussed above. The finalizer 508 may aggregate the verified billing entries from the reviser 530, and produce a bill formatted for receipt by the customer, including customer codes and formatted activity descriptions.

### SAMPLE EMBODIMENTS

FIG. 6 depicts an example method 600 of converting a manually entered billing description 602 to a customer accepted, standardized format billing description 610. In this example, the billing entry relates to time spent in preparing a response to a non-final office action from the U.S. Patent and Trademark Office.

First, the timekeeper enters an initial activity manually entered billing description 602. For example, in FIG. 6, the manually entered billing description 602 reads: “IDS REPORT: Paralegal time in reporting IDS to customer and updating database regarding each document cited in IDS.” This text is free form, unstructured text, and is not entered by the timekeeper with any codes. This text may be entered, for example, into the user interface of a billing entry utility program or application.

Next, the billing entry is analyzed for appropriate universal codes. The billing entry may be reviewed by natural language analysis, and a universal name 604 and information may be applied. For example, a natural language analysis could determine the task being performed falls into the category defined by the universal name “IDS/SIDS,” which translates to a universal invoice entry of “Legal Services for IDS/SIDS.” This category indicates a specific identification rule.

This information may be correlated in a database to a universal code 606. For example, Legal Services for IDS/SIDS may be correlated to a universal code UVSL-US-28.1. This code may be associated with the billing entry during subsequent processing of the billing entry.

The universal code may then be correlated to a customer code 608. For example, a customer code for an IDS/SIDS billing entry may be a US-Customer-28 code. This code may indicate, for example, a revision of the activity description. Instead of “IDS REPORT: Paralegal time in reporting IDS to customer and updating database regarding each document cited in IDS,” the customer code could indicate this should be replaced with a simple coded activity description 610, such as a number “214.” This may prepare the billing entry for placement on a bill to a customer with lesser chance of bounce back.

### Computer Embodiment

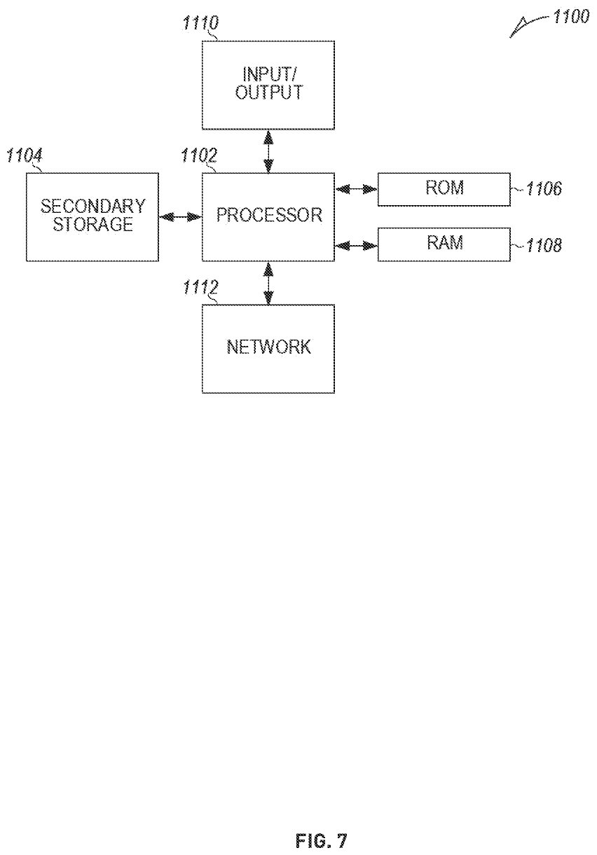

FIG. 7 is a block diagram of a typical, general-purpose computer 1100 that may be programmed into a special purpose computer suitable for implementing one or more embodiments of the automated billing verification system disclosed herein. The automated billing verification system described above may be implemented on any general-purpose processing component, such as a computer with sufficient processing power, memory resources, and communications throughput capability to handle the necessary workload placed upon it. The computer 1100 includes a processor 1102 (which may be referred to as a central processor unit or CPU) that is in communication with memory devices including secondary storage 1104, read only memory (ROM) 1106, random access memory (RAM) 1108, input/output (I/O) devices 1110, and network connectivity devices 1112. The processor 1102 may be implemented as one or more CPU chips or may be part of one or more application specific integrated circuits (ASICs).

The secondary storage 1104 is typically comprised of one or more disk drives or tape drives and is used for non-volatile storage of data and as an over-flow data storage device if RAM 1108 is not large enough to hold all working data. Secondary storage 1104 may be used to store programs that are loaded into RAM 1108 when such programs are selected for execution. The ROM 1106 is used to store instructions and perhaps data that are read during program execution. ROM 1106 is a non-volatile memory device that typically has a small memory capacity relative to the larger memory capacity of secondary storage 1104. The RAM 1108 is used to store volatile data and perhaps to store instructions. Access to both ROM 1106 and RAM 1108 is typically faster than to secondary storage 1104.

The devices described herein may be configured to include computer-readable non-transitory media storing computer readable instructions and one or more processors coupled to the memory, and when executing the computer readable instructions configure the computer 1100 to perform method steps and operations described above with reference to FIG. 4 to FIG. 6. The computer-readable non-transitory media includes all types of computer readable media, including magnetic storage media, optical storage media, flash media and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through physical medium or distribution system, including, for example, from a server owned by the software creator or from a server not owned but used by the software creator. The software may be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments may be implemented, at least in part, in digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. A computing program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative embodiments may be performed by one or more programmable processors executing a computing program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

### NOTES AND EXAMPLES

The following, non-limiting examples, detail aspects of the present subject matter to solve the challenges and provide the benefits discussed herein, among others.

Example 1 may include a computerized method of creating a customer formatted billing entry in a computerized billing system, comprising: receiving billing information including an activity description; associating a universal code with the billing information based on the activity description; applying a customer code to the billing information based on the universal code; and substituting a revised activity description for the activity description, the revised activity description corresponding to the customer code to produce the customer formatted billing entry.

Example 2 may include Example 1, wherein the activity description comprises free text.

Example 3 may include any of Examples 1-2, wherein receiving billing information comprises receiving data from a billing entry utility.

Example 4 may include any of Examples 1-3, further comprising analyzing the billing information by detecting and categorizing key words or phrases in the activity description for association with the universal code.

Example 5 may include any of Examples 1-4, wherein associating the universal code comprises applying one or more rules to the billing information, each of the one or more rules indicating a universal code to associate with the billing information.

Example 6 may include any of Examples 1-5, wherein applying the customer code comprises applying one or more customer rules to the billing information, each of the one or more customer rules associated with one or more customer codes.

Example 7 may include any of Examples 1-6, wherein the billing information further comprises one or more fields containing additional information.

Example 8 may include any of Examples 1-7, wherein the additional information comprises at least one of a customer name, a matter number, one or more associated entry codes, or a timekeeper name.

Example 9 may include any of Examples 1-8, further comprising standardizing text in the one or more fields of the billing information based on at least one of the universal code or the customer code.

Example 10 may include any of Examples 1-9, wherein the additional information further comprises a number of hours worked and a timekeeper rate.

Example 11 may include any of Examples 1-10, further comprising calculating a billing amount based on the number of hours works and the timekeeper rate, and including the billing amount in the customer formatted billing entry.

Example 12 may include any of Examples 1-11, further comprising the additional information including information specifying at least a portion of a history of activities associated with the billing information.

Example 13 may include any of Examples 1-12, further comprising formatting the billing entry by altering an appearance of the customer formatted billing entry according to a customer rule associated with the customer code.

Example 14 may include any of Examples 1-13, wherein associating the universal code comprises applying one or more rules to the billing information, each of the one or more rules indicating the universal code to associate with the billing information.

Example 15 may include any of Examples 1-14, further comprising generating a machine readable invoice containing machine readable data specifying the customer code and the customer formatted billing entry.

Example 16 may include a system for creating a customer formatted billing entry, the system comprising: a memory that stores instructions for implementing a billing entry utility, a billing entry transfer engine, and a billing entry coding engine; and one or more processors that execute the instructions to perform operations including: the billing entry utility receiving an uncoded billing entry comprising an activity description; the billing entry transfer engine associating a universal code with the uncoded billing entry based on the activity description to produce a universally coded billing entry; and the billing entry coding engine associating a customer code with the universally coded billing entry to produce a customer coded billing entry comprising a customer formatted activity description.

Example 17 may include Example 16, wherein the billing entry utility comprises at least one of a docketing program, a billing program, or a timekeeping program.

Example 18 may include any of Examples 16-17, wherein the billing entry utility comprises a user interface for receiving one or more uncoded billing entries.

Example 19 may include any of Examples 16-18, wherein the billing entry transfer engine and the billing entry coding engine are integrated with each other.

Example 20 may include any of Examples 16-19, wherein the billing entry transfer engine comprises one or more rules associating the uncoded billing entry with the universal code.

Example 21 may include any of Examples 16-20, wherein the billing entry coding engine comprises one or more rules associating the universally coded billing entry with the customer code.

Example 22 may include a non-transitory computer-readable storage medium, the computer-readable storage medium including instructions that, when executed by one or more processors, cause the one or more processors to create a customer formatted billing entry by performing operations to: receive billing information including an activity description; associate a universal code with the billing information based on the activity description; apply a customer code to the billing information based on the universal code; and substitute a revised activity description for the activity description, the revised activity description corresponding to the customer code to produce the customer formatted billing entry.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A computerized method of creating a customer formatted billing entry in a computerized billing system, comprising:
receiving billing information including an activity description;
associating a universal code with the billing information based on the activity description;
applying a customer code to the billing information based on the universal code; and
substituting a revised activity description for the activity description, the revised activity description corresponding to the customer code to produce the customer formatted billing entry.

2. The method of claim 1, wherein the activity description comprises free text.

3. The method of claim 1, wherein receiving billing information comprises receiving data from a billing entry utility.

4. The method of claim 1, further comprising analyzing the billing information by detecting and categorizing key words or phrases in the activity description for association with the universal code.

5. The method of claim 1, wherein associating the universal code comprises applying one or more rules to the billing information, each of the one or more rules indicating a universal code to associate with the billing information.

6. The method of claim 1, wherein applying the customer code comprises applying one or more customer rules to the billing information, each of the one or more customer rules associated with one or more customer codes.

7. The method of claim 1, wherein the billing information further comprises one or more fields containing additional information.

8. The method of claim 7, wherein the additional information comprises at least one of a customer name, a matter number, one or more associated entry codes, or a timekeeper name.

9. The method of claim 7, further comprising standardizing text in the one or more fields of the billing information based on at least one of the universal code or the customer code.

10. The method of claim 7, wherein the additional information further comprises a number of hours worked and a timekeeper rate.

11. The method of claim 10, further comprising calculating a billing amount based on the number of hours works and the timekeeper rate, and including the billing amount in the customer formatted billing entry.

12. The method of claim 7, further comprising the additional information including information specifying at least a portion of a history of activities associated with the billing information.

13. The method of claim 1, further comprising formatting the billing entry by altering an appearance of the customer formatted billing entry according to a customer rule associated with the customer code.

14. The method of claim 1, wherein associating the universal code comprises applying one or more rules to the billing information, each of the one or more rules indicating the universal code to associate with the billing information.

15. The method of claim 1, further comprising generating a machine readable invoice containing machine readable data specifying the customer code and the customer formatted billing entry.

16. A system for creating a customer formatted billing entry, the system comprising:
a memory that stores instructions for implementing a billing entry utility, a billing entry transfer engine, and a billing entry coding engine; and
one or more processors that execute the instructions to perform operations including:
the billing entry utility receiving an uncoded billing entry comprising an activity description;
the billing entry transfer engine associating a universal code with the uncoded billing entry based on the activity description to produce a universally coded billing entry; and
the billing entry coding engine associating a customer code with the universally coded billing entry to produce a customer coded billing entry comprising a customer formatted activity description.

17. The system of claim 16, wherein the billing entry utility comprises at least one of a docketing program, a billing program, or a timekeeping program.

18. The system of claim 16, wherein the billing entry utility comprises a user interface for receiving one or more uncoded billing entries.

19. The system of claim 16, wherein the billing entry transfer engine and the billing entry coding engine are integrated with each other.

20. The system of claim 16, wherein the billing entry transfer engine comprises one or more rules associating the uncoded billing entry with the universal code.
